(19) United States
(12) Patent Application Publication
(10) Pub. No.: US 2025/0223234 A1
(43) Pub. Date: Jul. 10, 2025

(54) Method of Manufacturing a Cubic Boron Nitride (CBN) Bushing with Improved Temperature Control and Wear Resistance

(71) Applicant: Tracy McSheery, San Leandro, CA (US)

(72) Inventor: Tracy McSheery, San Leandro, CA (US)

(21) Appl. No.: 18/405,301

(22) Filed: Jan. 5, 2024

(51) Int. Cl. C04B 35/5831; C03B 37/08; C03B 37/095; C04B 41/00; C04B 41/81

(52) U.S. Cl. CPC C04B 35/5831; C03B 37/0805; C03B 37/095; C04B 41/0036; C04B 41/81

(57) ABSTRACT

The present one embodiment provides a method for manufacturing a bushing utilizing Cubic Boron Nitride (CBN) discs. The initial fabrication of the CBN discs involves selecting a suitable grain size of CBN powder, compacting the powder into a preliminary bushing shape, and sintering it at a sufficient temperature to bond the grains securely. Post-sintering, the CBN form is machined into the final bushing shape with precise tolerances. This method further includes forming holes in the CBN disc, assembling the discs into an array with the desired number of fibers, and creating a carrier to hold this array.

### BACKGROUND OF THE INVENTION

For over a hundred years, glass and basalt fibers have been drawn through metal bushings such as platinum rhodium alloys, where the aperture of the melt helps determine the fiber diameter based on the mechanical drawing or pulling the melt through and then winding the fiber as it flows through the aperture, and is dependent on the viscosity of the melted material, and temperature. Necking from approximately 3 millimeters diameter (often ranging from 1 to 5 mm depending on the desired attributes) down to microns is done with a combination of surface tension and mechanical tension as the fiber cools and hardens. Each hole roughly 3 mm in diameter has a flow rate of material on the order of 20 to 60 grams per hour for a fiber that is 20 to 40 micrometers in diameter. The process creates a flexible group of many fibers called a tow or yarn, which through the drawing process makes the material flexible and stronger in tension. Since stronger fibers per weight tend to have narrower diameters, bushings tend to have thousands of holes to produce several kilograms of product per hour per bushing. The success of this method with platinum rhodium bushings has led to the wide adoption and optimization of these materials despite the high costs of platinum and rhodium. A bushing provides the interface between the melt and the outside workspace, with a mechanical and thermal transition from the molten material to the fiber, rod or other shape. Fibers are more flexible as the stiffness or moment is proportional to the fourth power of the diameter, and by definition the flaws are less than a diameter, so a bundle of fibers of unit weight will have a high strength to weight ratio for a given material. Smaller fibers improve on this property but become difficult to manufacture in bulk.

Bushings and dies are widely used in a variety of materials processing to create wire, rods and extrusions or by drawing them usually from heated bulk materials. The main difference in making glass and basalt fibers is the high temperatures required and the fine tolerances needed to make a consistent product. In the manufacture of glass or basalt fibers, their primary purpose is to distribute bulk material that can be formed into a thread or fiber on the order of microns in diameter, and conveniently group them into a yarn or tow, which can consist of dozens to thousands of fibers. During high-stress, high temperature applications, conventional materials such as steel or brass used in metal bushings aren't effective as they may wear out rapidly or oxidize due to the excessive heat, leading to reduced operational efficiency, equipment breakdown, and overall increased maintenance cost. Precious metals are used most often due to their low oxidation rates, high melting temperatures, and low chemical reactivity at the target temperatures.

The bushings for glass and basalt fibers are often trays fabricated with a platinum rhodium alloy, with holes fabricated in them, can have one to thousands of holes allowing thousands of fibers to be drawn simultaneously and the conductivity of the alloy allows the final heating to be achieved by running large amounts of current through the bushing itself, to control the temperature and thereby the viscosity. Conventionally, bushings are made of platinum alloyed with rhodium for the manufacture of glass or basalt fibers due to its resistance to deformation and corrosion at the high temperatures required to allow the fibers to be drawn. Most other materials would quickly fail or erode so fast, their continuous replacement would lower the productivity of the furnace and system.

Basalt Fiber is generally 80 percent of the strength of carbon fiber and a fraction of the costs. S Glass and E glass have excellent characteristics and also can be manufactured by heating the melt and drawing it through a bushing.

The use of Basalt and Glass Fibers is limited by their costs and energy as the raw materials costs are only a few dollars per ton. For instance Basalt Rock suitable for Basalt Fiber is approximately $20 per ton, or a penny a pound. The energy to produce glass fiber or basalt fiber can be thirty times that cost, making it an energy intensive process, although still less energy intensive than production of steel and other materials used in large quantities. Those materials benefit from established industries in a market consuming millions of tons per year, lowering the amortized manufacturing price. The current production methods for glass and basalt fibers limit their ability to manufacture product in such large quantities, so a method that will allow greater production can have a large impact on the world production of fibers creating a net benefit for energy, as well as product lifetime as products made with basalt and glass fibers are corrosion resistant and stronger as well as lighter, but due to high costs are limited to niche markets currently.

Basalt is an Igneous rock and about 90 percent of all lava flows form Basalt Rock, making it abundant with almost no processing required unlike steel, plastics and other building materials.

Layers of basalt formations are found in any region and represent trillions of tons of available material which could be turned into product replacing steel and other materials with less energy than steel or other parts and be easily recycled.

Mining and transportation are the real costs of the rocks, so locating the Basalt Manufacturing locations near suitable deposits, which have an ideal ratio of Silicon, Magnesium, Aluminum and Iron helps to lower the total production costs.

Basalt generally has a composition of 45-52 wt % SiO2, 2-5 wt % total alkalis, 0.5-2.0 wt % TiO2, 5-14 wt % FeO and 14 wt % or more Al2O3. Contents of CaO are commonly near 10 wt %, those of MgO commonly in the range 5 to 12 wt %. E-Glass and S-Glass often have proprietary formulations but are largely SiO2 Al O (aluminum oxide or alumina), CaO (calcium oxide or lime) and MgO (magnesium oxide or magnesia) with variations in composition to target particular mechanical strength or chemical properties.

One of the current problems with manufacturing basalt fiber is the composition of the rock can vary and there is difficulty in mixing in constituents which would balance the composition towards a more ideal ratio of SiO2, alkalis, TiO2, MgO, FeO, CaO and Al2O3. Increasing the melt temperature would facilitate adding extra materials to provide a more uniform output than the natural distribution.

The limiting factor is the chemistry of materials at temperatures such as 1350 to 1500° C. or 1623 to 1773° Kelvin where as an example basalt rock melts and can be drawn as a liquid that necks down and quickly forms a fiber with diameters in the 1 to 100 micron diameter range. Raising or lowering the temperature will change the viscosity and the resultant fiber thickness but eventually chemical attack with the bushing or contaminants in the melt can cause either erosion, build up or pitting of the aperture of the bushing and can change the volume through the aperture of material at that temperature changing the diameter of the fiber with respect to the surrounding fibers, resulting in an inconsistent product. Certain aggressive fluxes or impurities can cause chemical reactions, leading to bushing degradation and fiber contamination. E glass and S glass have similar issues but are less limited due to lower temperatures for production. Benefits of this invention would carry over to many types of glass fiber production.

Major challenges associated with manufacturing basalt fibers are:
Crystallization: Structural parts such as magnetite can crystallize gradually and having a higher melting temperature can plug or restrict the flow. Other crystallites that can form can produce fiber defects reducing the mechanical strength.
Non-homogeneity: The melt can be non-homogeneous.
Contact angle: The decreasing contact angle can cause the melt to spread on the bushing surface instead of forming a stable spinning cone.
Clogging: Crystals can form in the bushing or orifice, causing clogging.
Cost: PtRh is a precious metal alloy, making it significantly more expensive than alternative bushing materials like alumina or zirconia. This can be a major drawback for large-scale fiber production.
Reactivity: While PtRh is highly resistant to corrosion from molten glass and basalt, certain aggressive fluxes or impurities can cause chemical reactions, leading to bushing degradation and fiber contamination.
Brittleness: Although robust, PtRh is still a brittle material and susceptible to cracking or chipping under high mechanical stress or thermal shock. This can lead to bushing failure and production downtime.
Limited service life: While PtRh bushings offer longer lifespans than many alternatives, they eventually wear out due to abrasion and thermal cycling. The rate of wear depends on the fiber material, drawing conditions, and bushing geometry.
Thermal conductivity: PtRh has a lower thermal conductivity compared to some other bushing materials like copper. This can make it challenging to maintain consistent fiber temperature profiles during the drawing process, potentially impacting fiber quality.
Temperature control: insufficient temperature and control of the process can cause melt dripping, fiber breaks, defects and poor mechanical properties.

### SUMMARY OF THE INVENTION

A method to produce basalt and glass fibers at temperatures exceeding 800° C. and less than 3500° C. using Cubic Boron Nitride (CBN) and Pyrolytic Boron Nitride (PBN) collectively noted as BN, as well as other materials in a nitrogen or inert atmosphere is disclosed.

In another aspect, a method is disclosed for manufacturing a bushing utilizing CBN discs. The initial fabrication of the CBN discs involves selecting a suitable grain size of CBN powder, compacting the powder into a preliminary bushing shape, and sintering it at a sufficient temperature to bond the grains securely. Post-sintering, the CBN form is machined into the final bushing shape with precise tolerances. This method further includes forming holes in the CBN disc, assembling the discs into an array with the desired number of fibers, and creating a carrier to hold this array. Also, a system is included for inspecting and maintaining the array of CBN discs.

Advantages of the system may include one or more of the following. The system will reduce the cost and improve the productivity of manufacturing continuous and chopped fiber which have uses in construction and buildings both as reinforcement bar (rebar) and chopped fiber for concrete, as well as composites materials in automobile, aircraft and other manufacturing industries. By lowering the costs of the bushings, potentially increasing the number of holes, and allowing smaller holes, the quality of the fiber can be improved, without decreasing the productivity of the furnace and bushing in terms of kilograms of fiber produced per day, increasing the value of the end product. Normally smaller holes are more prone to corrosion, and fouling, so a compromise is made to maximize yield. Since the furnace has to be shut down and cooled, to allow the bushing to be replaced, and then gradually raised to operational temperature again, a process that can take days to weeks, the downside to smaller and more holes has been outweighed by production concerns for 100 years. The high strength of glass fibers and low weight, being on the order of one quarter the specific gravity of steels, while demonstrating superior strength, provide excellent mechanical properties and improvement of the production process which lowers the costs has a disproportionate benefit to the environment and industry.

CBN is one of the hardest materials known, and is able to reach temperatures over 1000° C. before it begins to oxidize, and in inert atmospheres can operate up to 1500° C. The thermal conductivity of CBN is 1300 W/mk, or almost 20 times the thermal conductivity of Platinum, allowing much more uniform heat distribution, and an even temperature throughout the surface of the bushing, which should improve process control. The relatively low cost and commercial availability of CBN and Pyrolytic BN can allow systems to be designed where inserts of BN can be removed and replaced in situ in a melt of molten basalt rock, without having to lower the system temperature to room temperature, improving production and decreasing downtime.

### BRIEF DESCRIPTION OF DRAWINGS

FIG. 1 shows an exemplary process for fabricating each CBN disc.

FIG. 2 shows an exemplary method of making a bushing.

FIG. 3 shows exemplary methods to inspect, replace and create spares of bushing discs and then resume operations.

### DETAILED DESCRIPTION OF THE INVENTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

This invention now will be described more fully hereinafter with reference to the accompanying drawings, in which exemplary embodiments are shown. Various embodiments are now described with reference to the drawings, wherein such as reference numerals are used to refer to such as elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the such as represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The aforementioned one embodiment puts forward a new method to design and construct a bushing. The core of the process requires the fabrication of multiple Cubic Boron Nitride (CBN) and Pyrolytic Boron Nitride (PBN) discs, an extremely hard and thermally conductive material, thus imparting high temperature and wear resistance to the bushing. The discs are specifically designed to have custom holes in them to accommodate the fabrication of fibers. Therefore, these discs efficiently incorporate desired fiber formation properties such as shape, size, number of holes or apertures, and thermal properties, while maintaining their integrity, durability and their ability to withstand extreme conditions.

Cubic Boron Nitride (CBN), known for its hardness and thermal conductivity, has been found to be an excellent material for bushings, particularly in contexts where high stress and temperatures are involved. CBN bushings are expected to exhibit superior wear resistance and longevity compared to bushings made from conventional materials. However, the techniques for fabricating CBN bushings that combine mechanical strength, thermal conductivity, and desirable dimensional tolerances are not well perfected. The affordable nature of these materials lend themselves to create a system solution whereby they can be considered consumables and designed to be easy to maintain and replace, while keeping the furnace and bushing at an elevated temperature to reduce downtime during maintenance.

Furthermore, existing fabrication methods are not equipped to ensure uniform temperature regulation across the CBN disc during manufacture, potentially compromising the bushing's longevity and performance.

This one embodiment seeks to address these challenges by introducing a method for manufacturing a CBN bushing, ensuring a precise balance between mechanical strength and thermal conductivity, exact dimensional tolerances, and an enhanced wear resistance via a replaceable system at near operational temperature.

The process then employs the assembly of the fabricated CBN discs into a specified array with a predetermined number of fibers produced. The arrangement of these discs plays a crucial role in achieving the desired performance characteristics of the final product. This flexibility in the arrangement allows us to create bushings suited to a myriad of applications with varying requirements.

The next step of the method is to construct a carrier specifically designed to hold the arranged array of CBN discs. This carrier ensures the safe and steady locating of the discs, consequently allowing the construction of bushings of uniform features, regardless of their size, complexity, or the extent of application. It facilitates high levels of precision and consistency in the final product, minimizing errors, irregularities and deviations.

The discs in the carriers are then subjected to temperature control regulation using a heater. Different temperatures can be regulated throughout the construction process as per the need for varying the hardness, resilience, and other performance traits of the bushings. The use of a heater in managing the temperature of the discs allows tighter control over the performance characteristics of the finished bushing.

The optimal bushing material depends on various factors, including:
Drawn Fiber material and composition
Drawing temperature and speed
Flux composition and purity
Production volume and cost considerations

The diameters of the holes or apertures can be modified during fabrication depending on the target temperature, so raising the melt temperature might allow bushings with smaller apertures and or more apertures to achieve the desired characteristics of the fiber. This would allow a more productive system and more efficient heating.

Additionally using Graphite heat shields between the apertures would allow controlling the temperature for the proper necking profile, maintaining temperature as it exits but then once it reaches the desired 10 micron diameter (as an example), rapidly cooling the fiber.

The Platinum Rhodium Alloy Bushing is replaced by relatively low cost synthetic Cubic Boron Nitride (CBN) or Pyrolytic Boron Nitride (PBN), in a fixture made out of ceramics or Tungsten or suitable material. Boron Nitride has a melting temperature of over 3000° C. and is chemically resistant to attack or corrosion by metals and oxides allowing a maximum working temperature of about 1900° C. for CBN and up to 2400 C for PBN, whereas Platinum alloys have a maximum working temperature of about 1600° C.

Blanks of Polycrystalline Cubic Boron Nitride are available at about 100 mm diameter and variable thickness. It is easily cut and shaped by laser machining. Larger material sizes and thicknesses may be obtained given sufficient market forces, making the limitations market driven versus fundamental mechanical and physics limitations. The low coefficient of thermal expansion (CTE) is attractive given the wide temperature range from room temperature up to an operating temperature of about 1350° C. to 1500° C. being approximately two to four times lower CTE than Platinum alloys.

The Semiconductor nature of the CBN may allow for heating or pyrolytic graphite can be sandwiched onto the BN as it is done with Pyrolytic BN.

The numerous configurations that this method allows for the assembly of bushings from CBN discs and structures make it extremely adaptable. Different disc materials and designs, to address varying the number of apertures, different fiber types, disc layering alignments and temperature control measures can all be varied as per the specific needs of the application, making this method universally applicable.

The consistent reliability of the bushings produced by this method regardless of alterations in configuration makes it a highly dependable process. The precise control over each step-from disc manufacture, through arrangement in array and carrier, to the temperature regulation-ensures a predictable and consistent outcome that can be relied upon in an array of different industries and applications.

The technological simplicity and adaptability of this method is stark. Requiring only the fabrication of CBN disc, fiber arrangement, carrier design, and a heater for temperature control, it is a method that can be employed in settings ranging from small, bespoke manufactures to large-scale commercial production. The flexible nature of this one embodiment also makes for potential space and cost savings and allows for various adjustments in the bushing structure and customization of the end product.

The present one embodiment relates generally to the fabrication of Cubic Boron Nitride (CBN) discs to form a bushing to fabricate fibers of glass or basalt at high temperature under conditions where most materials would fail. The innovation disclosed herein provides for a method that allows the efficient, precise and reliable production of CBN based bushings that can be easily removed and replaced as they wear. This is crucial given despite CBN's high hardness level and thermal conductivity, properties which render it ideal for usage in various commercial applications particularly in the field of machining, as cutting tools or abrasive materials at the temperatures and conditions required to fabricate large quantities of basalt and glass fiber, no material will last indefinitely so a system to leverage the best properties and make it easy to repair and replace components reduces the system costs and improves the productivity, by not having to cool the furnace to replace the bushings as is currently the practice for over 100 years.

The discs can be used as bushings which are used to draw molten flux or melt into one or more fibers. A bushing is more commonly a type of bearing, a mechanical element used to reduce friction and wear between rotating or sliding parts. The shape of a bushing is typically cylindrical, although they can come in various forms depending on their specific application. The basic structure of a bushing usually consists of an inner surface, an outer surface, and sometimes a flange or collar. The Inner Surface is the surface that interacts with the shaft or rod that passes through the bushing. It needs to be smooth and may be coated or treated depending on the application to reduce friction and wear. The Outer Surface interacts with the housing or bore in which the bushing is installed. The fit between the outer surface of the bushing and the housing is crucial for proper function, often requiring precise tolerances. Some bushings have a flange or collar at one end. This feature helps in positioning the bushing within its housing and can also prevent axial movement. In this instance, a bushing is a system comprised of one or many apertures, of cylindrical nature to allow a molten fluid such as a glass melt or flux, or a basalt melt, to flow through an aperture and then due to gravity and mechanical methods neck down from the exit aperture diameter to the design fiber thickness.

In the disclosed method, the fabrication of each CBN disc includes several process steps. Initially, a blank CBN disc is created. This disc serves as the elemental piece manipulated throughout the process. Thereafter, a laser beam or equivalent method is used to cut holes through this blank disc. This provides a precise, clean and efficient way of generating the necessary apertures on the disc in contrast to previously employed mechanical etching or drilling processes. To reduce any potential surface flaws and increase the disc's lifetime, the edges of these laser-cut holes are then radiused or chamfered. As the laser cutting process could potentially expose the disc to oxidizing conditions, a protective barrier may be applied subsequently on one face of the disc to shield it from oxygen exposure. This barrier ensures the integrity of the disc's composition and crystalline structure is unaffected during the fabrication and usage. Additional layers can be machined to provide support structures, or nozzles, or other devices to increase the productivity of the system. This also allows for the integration of consumable sections or features as opposed to the current all or nothing approach with the Platinum Alloy Bushings.

The process finalizes via application of a fabrication method through these laser-cut holes to form a disc insert. The laser machining method is favorable given the tight tolerances possible and its ability to create a seamless integration of the inserts into the disc. This method also allows for various forms of inserts, such as including elements with different thermal, mechanical or wear resistant properties, to be successfully embedded within the disc. Thus, this one embodiment provides an integrated and flexible method for the fabrication of CBN discs that may be beneficial not only for the disc production process but also for the operational parameters of the resultant CBN discs. This precise, protective, and customizable method thus improves upon the existing manufacturing process of CBN discs, potentially leading to significant benefits across various industries.

This one embodiment relates to a method for fabricating a bushing made from Cubic Boron Nitride (CBN) and or Pyrolytic Boron Nitride (PBN) that offers superior performance in high temperature, high-stress applications. This innovative approach involves the selection of CBN materials that are commercially available in other areas, and are therefore more affordable than precious metals, but that have previously not been practical to form in complex shapes to make a structure necessary to improve the process of mass producing glass or basalt fibers. The CBN or PBN, is selected to provide the necessary hardness and strength for the creation of a robust, enduring, and highly wear-resistant product. The selection of a suitable material for the fabrication of a CBN bushing that can withstand high temperature, high-stress applications without experiencing significant wear, deformation, or failure.

The fabrication process starts with compacting the carefully selected CBN powder into a preliminary bushing shape through the application of high pressure. This step ensures the particles of the CBN powder align and interlock in a manner that increases the overall strength and durability. After the CBN powder has been formed into the preliminary bushing shape, it is then sintered, meaning it is heated to a temperature adequate enough to encourage the bonding of grains but without inducing significant grain growth. The sintering stage is critical, as it enables the creation of a sturdy bushing that resists wear and can bear high levels of stress without breaking.

The final steps of the fabrication method involve machining the sintered CBN into a final bushing shape that has the desired dimensional tolerances for the specific application. This means that the innovative CBN bushing can be custom made to fit any existing or new machinery, ensuring secure placement and preventing any potential damaging movements during operation. Finally, the machined bushing may be coated with a lubricative film. This not only improves the wear resistance of the bushing but also minimizes friction, reducing the chances of overheating and further extending the lifespan of the bushing. Thus, this one embodiment presents a method for fabricating a high-performance CBN bushing that exhibits excellent wear resistance, reduced friction, and high endurance under stress.

The present one embodiment is designed to optimize thermal conductivity while maintaining sufficient mechanical strength, for specific use in high temperature environments where these properties are critical to successful operation. This necessity arises due to the process of melting glass or basalt rock and then trying to fabricate hundreds or thousands of fibers that are uniform in diameter, mechanical properties and chemical properties in a furnace environment, where materials must withstand various thermal and mechanical stresses, impacts, and temperature fluctuations. The innovation lies primarily in the selection of materials that can be constructed to perform in these environments, and resist the harsh conditions, but be affordable by replacing expensive metals like Platinum Rhodium with composites, that can achieve an ideal equilibrium between mechanical strength and thermal conductivity.

The present one embodiment discloses a method fundamentally involved in the maintenance of an array of cubic boron nitride (CBN) discs. This cutting-edge method ensures a prolonged lifespan of these abrasive discs, thereby enhancing the efficiency and durability of the respective system where they are installed. The method comprises inspecting each disc insert for signs of wear, damage, or other characteristics that might affect the performance of the disc. This inspection process is meticulous, ensuring that only the highest quality and most optimum performance can be achieved by each disc insert. This technique allows for the preemptive identification of any potential issues that might have an adverse effect on the overall operations.

Once thoroughly inspected and any faulty or worn-out disc is identified, the following step is executed. This step involves placing a plug in the defective or ‘bad’ hole where the problematic aperture in the inspected disc was originally situated. The accurate placement of this plug thoroughly seals off the hole to prevent any inadvertent insertion or reinstating of a faulty disc. This method ensures the stability and overall lifespan of the entire array, averting any compromises that may stem from inadvertent use of a defective disc.

The last stage of this inventive method involves removing the plug from one or more spare apertures within the system, and plugging the problematic aperture. This process provides a space for additional apertures or holes to prolong the time needed for replacement discs to be inserted into the array. After the spares apertures are exhausted then a dam is inserted around the disk blocking flow of the melt into the center of the dam, and allowing the removal and replacement of the disc at a temperature close to the operating temperature, without significant interruption of the process. In some cases even an entire spare disc may be situated in the bushing allowing continued operation while maintenance is being done. Extensively inspected and approved spare discs are then placed into the removed disc's space, thereby replacing the faulty disc initially identified. The removal and replacement procedure is performed with utmost precision to maintain the array's balance and effectiveness. The reinstituted balance within the array extends the lifetime of the array overall, maintaining its peak performance standards, and reduces any necessary costs associated with premature disc replacement or entire system failure.

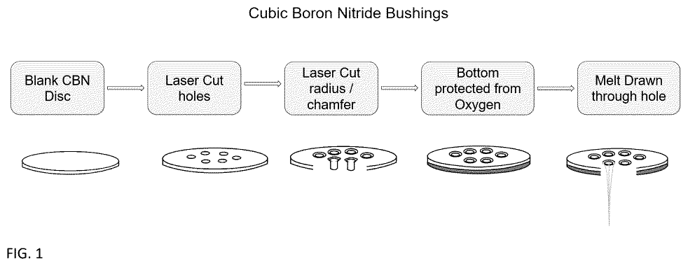

FIG. 1 shows an exemplary process for fabricating each CBN disc. The process includes:
forming a blank CBN disc;
cutting holes therethrough with a laser beam;
chamfering the laser cut;
protecting one face of the disc from oxygen with a protective barrier;
applying glass or basalt melt-drawn through the holes of a disc insert to form a fiber.

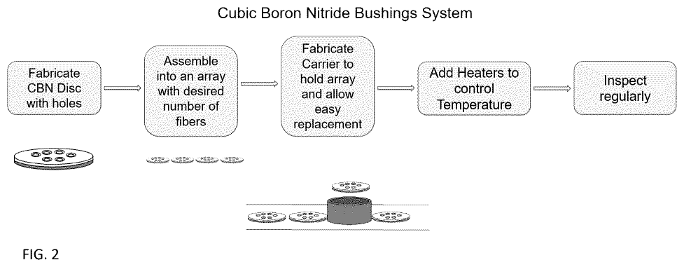

FIG. 2 shows an exemplary method of making a bushing. The method includes:
fabricating a plurality of Cubic Boron Nitride (CBN) discs with holes therein;
assemble the discs into array with a desired number of fibers;
fabricating a carrier to hold an array of the CBN discs;
controlling disc temperature with a heater possibly fabricated out of PBN.

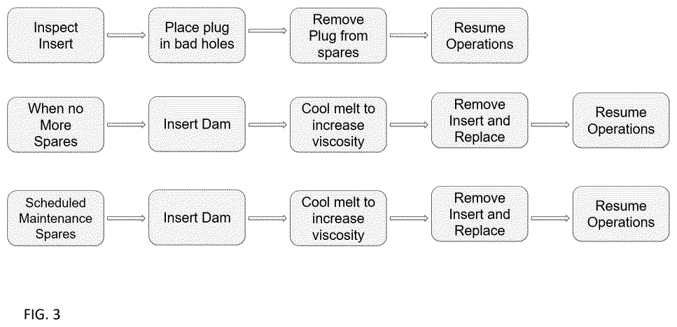

FIG. 3 shows exemplary methods to inspect, replace and create spares of bushing discs and then resume operations. The process includes maintaining the array of CBN discs by inspecting a disc insert; placing a plug in a bad hole; and removing the plug from one or more spare holes. If there is no spare available, the process includes inserting a dam; performing cooling to the melt to increase viscosity; and removing the insert and replacing the insert. The process also includes creating maintenance spares by inserting a dam; performing cool melt to increase viscosity; and removing the dam from a spare insert allowing a delay in replacing the insert.

The present one embodiment pertains to an innovative method particularly applicable in scenarios where there is no spare available. This method introduces a step that enables greater efficiency and performance by implementing an Insertion-Dam-Process. The primary function of the dam, in this case, is to temporarily halt the flow or movement within the system to which it is applied. This might typically involve a mechanical, hydraulic, or process scenario. The dam insertion is executed with precision and care to not disrupt the primary system, while ensuring that there is an effective temporary stoppage of flow through the particular section. This patent chiefly deals with those situations where replacement or repair is not immediately preferable or possible due to the lack of component availability.

The second stage of the one embodiment involves performing a cooling of the melt to increase viscosity-a crucial process to enhance the system performance. The idea is to considerably lower the temperatures at the insert site, thereby increasing the viscosity or “thickness” of the fluid or substance contained within the system. As the temperature drops, (from say 1500° C. to 1250° C. as an example, versus the current requirement to drop the temperature to 100° C. or less to remove the platinum bushing) the energy of the molecules decreases, thereby decreasing their movement and interaction, resulting in a higher viscosity level. Increasing viscosity lends greater control over the substance or fluid flow, manipulating its properties according to the requirement. This is particularly useful in controlling and mitigating any potential leaks, wicking, or other flow-related issues that might otherwise occur in absence of a spare component. This makes it easy to replace an insert and repair the bushing to quickly resume production by raising the temperature back to the operational temperature, versus the current method of cooling to near room temperature, replacing a platinum bushing with a spare, and raising the temperature over 1000° C., which causes significant thermal cycling and could lead to system failure after repeated cycles.

Finally, the process concludes with the removal of the dam and subsequent replacement of the insert. This stage ensures the system is returned to normal function as soon as a new insert or component becomes available. Although the one embodiment is designed to operate effectively even without a spare, the ultimate goal is to replace the affected part, restoring original performance. Therefore, the method is geared towards not just immediate damage control but efficient and convenient resolution of the issue. This one embodiment, therefore, aims to provide a reliable, effective, and flexible solution to manage situations where system failure is imminent due to a lack of necessary components.

The present one embodiment pertains to a method of creating maintenance spares, particularly in relation to mechanical and technological industries. The process is distinctive due to its unique three-stage procedure that targets the core concerns of our industry today, namely: efficiency, reliability, and material optimization.

The first step of the method involves inserting a dam into the work material. This dam serves a multitude of purposes, such as controlling the flow, developing a barrier for the excess material, and setting a defined area within which the subsequent processes will occur. The dam can be composed of various materials, with the choice depending on factors such as the work material's nature, the desired final result, and the operational conditions. The flexibility of the dam selection allows the method to cater to a wide array of applications and practical situations. It is also worth mentioning that the actual act of inserting the dam while the melt is still at a temperature most likely above 1000° C., allowing a quick return to full service, involves meticulous precision to ensure optimal results, which can be achieved manually or via automated means.

The second phase of the process is centered on performing a cooling of the melt to increase the viscosity of the work material. The objective here is to control the melt material's properties, keeping them near operating temperatures, versus lowering the entire system temperature to near room temperature, making the system for manufacturing fibers more robust, and ensuring that it can withstand a variety of conditions. The cooling of the melt technique is favorable over traditional repair of the bushing methods as it eliminates excessive system thermal cycling, thus contributing to a more controlled and sustainable process, reducing waste and avoiding component damage due to heat stress. This stage may also involve selectively controlling the cooling rate via suitable means, which provides additional control over material properties.

Finally, the concluding step involves removing the insert and replacing it. This is done to ensure both the insert and the work material's longevity. It may further involve inspecting and cleaning the insert slot to eliminate any residue or contaminant that can affect the next cycle. This step is significant for maintaining operational efficiency and material quality consistently. A unique aspect of this step is the possible recycling of removed inserts, aiding in waste reduction and cost efficiency.

This innovative method, thus, offers a comprehensive, sustainable, and efficient alternative for improved production of basalt and glass fiber as well as reducing down time and creating maintenance spares. It demonstrates considerable merit in terms of its functionality in a variety of industrial applications, making it a revolutionary step for industries striving for better management and use of their resources. The detailed steps and thoughtful design make this method not merely an operational process but a potential benchmark in its field.

The first phase of the patented method involves the making of a plurality of Cubic Boron Nitride (CBN). In the next stage, the CBN discs are assembled into an array. This array could consist of any desired number discs to form tows or yarns of fibers based on requirements.

A carrier used to hold the assembled array of CBN discs is then fabricated. This carrier is to hold the array in place during the other stages of the process and has to be made of a material capable of withstanding high pressure and temperature conditions.

The final step involves coating the completed bushing with a protective and or lubricative film. This additional layer helps to enhance the wear resistance of the bushing, ensuring longevity. It also reduces friction which aids in the overall performance of the bushing, making it more efficient in high-stress applications. In this way, the patented method helps manufacturers produce robust and efficient bushings for a variety of uses.

CBN bushings have applications in various industrial processes, including those involving rebarm, (reinforcement bar) manufacturing and processing. CBN bushings are particularly useful in applications involving high temperatures and stresses. Using CBN for bushings could offer several benefits:

High Wear Resistance: CBN's exceptional hardness makes it highly resistant to wear and abrasion. In basalt and glass fiber manufacturing, where machinery components operate well over 1000° C. and are subjected to constant chemical reactions, friction and mechanical stress, CBN bushings would last significantly longer than conventional materials, reducing downtime and maintenance costs.

Thermal Stability: CBN maintains its hardness and structural integrity at high temperatures, which is essential in processes involving heat, such as producing glass fibers.

Low Friction Coefficient: CBN's low friction properties can be advantageous in machinery where reducing resistance and heat generation is crucial, leading to more efficient operations and longer life for moving parts.

The resulting CBN bushing can be used in the following manufacturing applications:
Basalt Fiber
Glass Fiber
High Temperature extrusions of wire
Silicon Fiber
Alternative fibers requiring temperatures over 1000° C. to fabricate.

All of these applications benefit from lower cost and higher performance bushings with increased productivity.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. The various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the such as; the term “example” is used to provide exemplary instances of the item in discussion, not an exhaustive or limiting list thereof; the terms “a” or “an” should be read as meaning “at least one,” “one or more” or the such as; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Hence, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other such as phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of making a bushing, comprising:
fabricating a bushing of Cubic Boron Nitride (CBN) disc with holes therein;
modifying the disc with a desired number of apertures to form fibers;
fabricating a carrier to hold a CBN disc;
controlling bushing temperature with a heater.

2. The method of claim 1, wherein the fabricating of each CBN disc, further comprises:
fabricating an assembly with a plurality of Cubic Boron Nitride (CBN) discs with holes therein;
assemble the discs into array with a desired number of apertures to form fibers;
fabricating a carrier to hold an array of the CBN discs;
controlling bushing temperature with a heater.

3. The method of claim 1, wherein the fabricating of each CBN disc, further comprises:
forming a blank CBN disc;
cutting holes therethrough with a laser beam;
chamfering the laser cut;
protecting one face of the disc from oxygen with a protective barrier;
applying melt-drawn through the holes in the disc insert to form fibers.

4. The method of claim 1, further comprising selecting a PBN material to heat and control the temperature inside the melt providing a uniform melt temperature.

5. The method of claim 1, further comprising applying a thin layer of a protective and lubricative material to reduce wear and oxidation of the surfaces under the extreme temperatures.

6. The method of claim 1 where the discs are arrayed in a carrier such that they can be used to fabricate thousands of fibers by adding more discs where the carrier provides mechanical support and facilitates the assembly of the mechanical insertion and removal of the discs, dams and plugs to control the flow of melt as desired.

7. The method of claim 1, where the atmosphere is inert to reduce the rate of oxidation of the bushing and its components.

8. The method of claim 1, comprising maintaining the array of CBN discs by:
inspecting a disc insert;
placing one or more plugs in a bad hole; and
removing the plug from one or more spare holes.

9. The method of claim 8, if there is no spare available, further comprising:
inserting a dam;
performing cooling of the melt to increase viscosity; and
removing the previous insert and replacing with the new insert.

9. The method of claim 8, comprising creating maintenance spares by:
having extra inserts that are blocked from performing by dams during normal operation;
when upon inspection an insert is no longer performing and cannot be restored by adding plugs and removing plugs from holes;
inserting a dam, over poorly performing insert;
removing the dam over the spare insert;
continuing normal operation until further replacements are needed.

10. The method of claim 8, comprising creating maintenance spares by:
having extra bushings that are blocked from performing by a dam during normal operation;
when upon inspection a bushing is no longer performing and cannot be restored by adding plugs, removing plugs from holes or adding and removing inserts and associated dams;
inserting a dam, removing first bushing from operation;
performing cool melt regionally to first bushing to increase viscosity;
removing dam from second bushing placing it into operation, increase local heating; and
performing maintenance on first bushing, removing the inserts and replacing the inserts.

11. The method of claim 8, comprising:
forming one or more graphite heat shields to allow controlled cooling with a high temperature zone extended by the graphite initially heated by proximity;
adjusting the length for a target necking distanced from aperture; and
adjusting the thickness to provide thermal mass for retaining heat.

12. A system, comprising:
a plurality of Cubic Boron Nitride (CBN) disc with holes therein, wherein the disc is modified with a desired number of apertures to form fibers;
a carrier to hold the CBN disc; and
a heater to control disc temperature.

13. The system of claim 12, wherein the CBN discs are formed by:
forming a blank CBN disc;
cutting holes therethrough with a laser beam;
chamfering the laser cut;
protecting one face of the disc from oxygen with a protective barrier;
applying melt-drawn through the holes in the disc insert to form fibers.

14. The system of claim 12, wherein the discs form a bushing.
